(19) United States
(12) Patent Application Publication
(10) Pub. No.: US 2014/0119406 A1
(43) Pub. Date: May 1, 2014

(54) PROBE COVER FOR EAR THERMOMETER

(71) Applicant: ACTHERM INC, Hsinchu City (TW)

(72) Inventor: Min-Ying CHEN, Hukou Township (TW)

(73) Assignee: ACTHERM INC, Hsinchu City (TW)

(21) Appl. No.: 13/693,661

(22) Filed: Dec. 4, 2012

(30) Foreign Application Priority Data
Oct. 30, 2012 (TW) 101140026

(51) Int. Cl. G01K 1/08

(52) U.S. Cl. CPC G01K 1/086
USPC 374/209

(57) ABSTRACT

A probe cover for ear thermometer is disclosed. The probe cover is installed on the probe by a plurality of elastic recesses being disposed at an open end of the probe cover for ear thermometer. In accordance with the elasticity of the elastic recesses, the probe cover can be easily and firmly installed at the probe of the ear thermometer. The damage of the probe cover can be avoided because of over extending.

### BACKGROUND OF THE INVENTION

1. Field of the Invention

The present invention relates to a probe cover for ear thermometer. By installing several elastic depresses at the open end of the prove cover for ear thermometer, the probe cover for ear thermometer can easily cover the probe of the ear thermometer by the elasticity of the elastic depresses when the probe cover is installed on the ear thermometer so as to avoid the damage of the over extension.

2. Description of the Prior Art

According to the progress and the development of the technology, there are many body temperature measurement methods different from the conventional mercury thermometer are gradually developed, such as ear thermometer, forehead thermometer and so on. The ear thermometer is become the popular body temperature measure method because of the advantages of fast measurement, high accuracy, easy operation and so on.

The measure method of the ear thermometer is to input a probe of the ear thermometer into the ear canal of the patient and determine the body temperature by detecting the electromagnetic wave irradiated from the human body. By considering the heath safety, this kind of measuring method is required to directly contact the human body, so there is a probe cover used to house the probe before measuring by the ear thermometer and the probe cover is released and discarded after measuring the body temperature.

The conventional probe cover for ear thermometer is shown in FIG. 1 and includes a tapered main body 50 and a flange 52 extended from the bottom of the tapered main body 50. The tapered main body 50 or the flange 52 usually includes a protruding portion 54 configured to couple with an annular structure of the ear thermometer so as to fix the probe cover on the probe of the ear thermometer. However, the fixing method is required to push by the user when installing the probe cover and a probe cover releasing structure is required to release the probe cover from the probe and it is very inconvenient. The protruding portion 54 of the probe cover for the ear thermometer could be damage because of over extension when the protruding portion 54 is used.

Therefore, according to the problems above, the ear thermometer needs a probe cover, which can be easily and firmly installed when the ear thermometer is used, and it won't be damaged because of over extension.

### SUMMARY OF THE INVENTION

An object of the present invention is to provide a probe cover for ear thermometer, and the probe cover for ear thermometer is extendable. The probe cover for ear thermometer can be easily and firmly installed and won't be damaged because of over extending.

According to the object above, a probe cover for ear thermometer is disclosed in the present invention and the probe cover for ear thermometer is utilized for housing a probe of an ear thermometer and a bottom of the probe including an annular component, the probe cover for ear thermometer including a tapered main body with a hollow structure, the tapered main body including a first open end and a close end corresponding to the first open end, a diameter of the hollow structure is gradually shrunk from the first open end to the close end and the probe cover for ear thermometer includes an annular elastic portion, a flange, and a plurality of elastic recesses. The annular elastic portion is disposed adjacent to the open end to form a second open end, the second open end is an annular shape and the annular elastic portion includes an annular inner surface and an annular outer surface. The flange extends from the second open end and the flange includes a top surface and a bottom surface corresponding to the top surface and the top surface is faced to the close end. The elastic recesses are formed at the second open end, which is an intersection between the flange and the annular elastic portion. The gaps are formed at the elastic recess of the annular inner surface and the bottom surface of the flange and some protrusions are formed at the elastic recesses of the annular outer surface.

By using the probe cover for ear thermometer in the present invention, the annular open end of the probe cover for ear thermometer won't be damaged when it is extending because of the elastic concave. Because of the extension ability of the annular elastic portion, the probe cover for ear thermometer can be firmly installed on the probe of the ear thermometer.

The above-mentioned description of the present invention can be best understood by referring to the following detailed description of the preferred embodiments and the accompanying drawings.

### BRIEF DESCRIPTION OF THE DRAWINGS

FIG. 1 is a view illustrating a probe cover for ear thermometer in prior art;

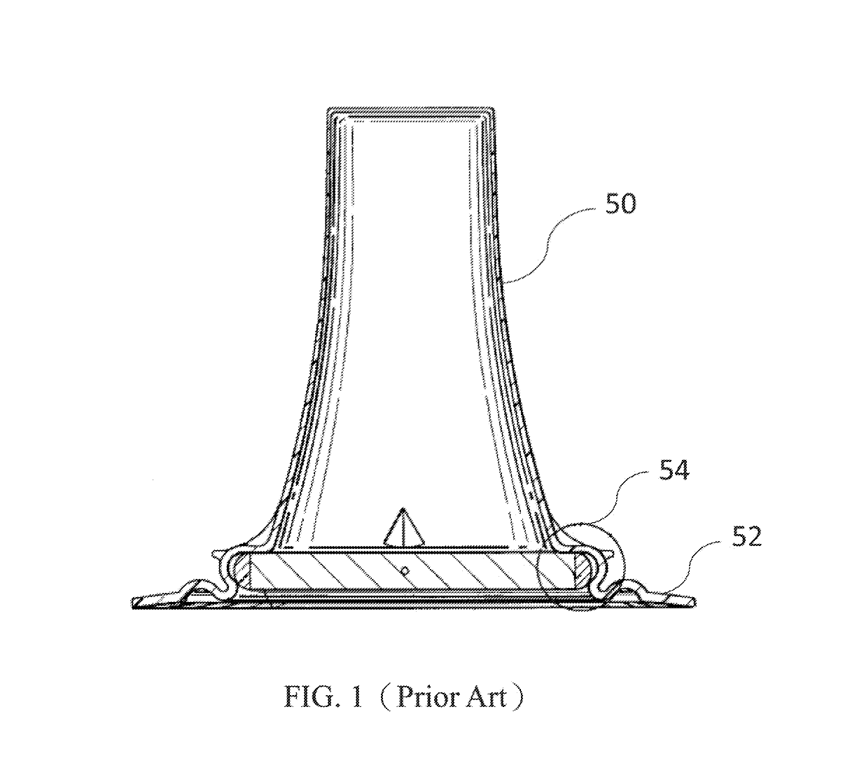

FIG. 2 is a side view illustrating a probe cover for ear thermometer in one embodiment of the present invention;

FIG. 3 is a top view illustrating the probe cover for ear thermometer in the same embodiment of the present invention;

FIG. 4 is a view illustrating a bore diameter comparing between the probe cover for ear thermometer and the probe in the same embodiment of the present invention;

FIG. 5A is a view illustrating an annular open end of the probe cover for ear thermometer in the same embodiment of the present invention before extending;

FIG. 5B is a view illustrating an annular open end of the probe cover for ear thermometer in the same embodiment of the present invention after extending; and

FIG. 6 is a view illustrating the probe cover for ear thermometer is installed on the probe in the same embodiment of the present invention.

### DESCRIPTION OF THE PREFERRED EMBODIMENT

In the following detailed description of the preferred embodiments, reference is made to the accompanying drawings which form a part hereof, and as shown by way of illustration specific embodiments in which the invention may be practiced. In this regard, directional terminology, such as “top,” “bottom,” “front,” “back,” “left,” “right,” “inside,” “outside,” “side,” etc., is used with reference to the orientation of the Figure(s) being described. As such, the directional terminology is used for purposes of illustration and is in no way limiting the present invention.

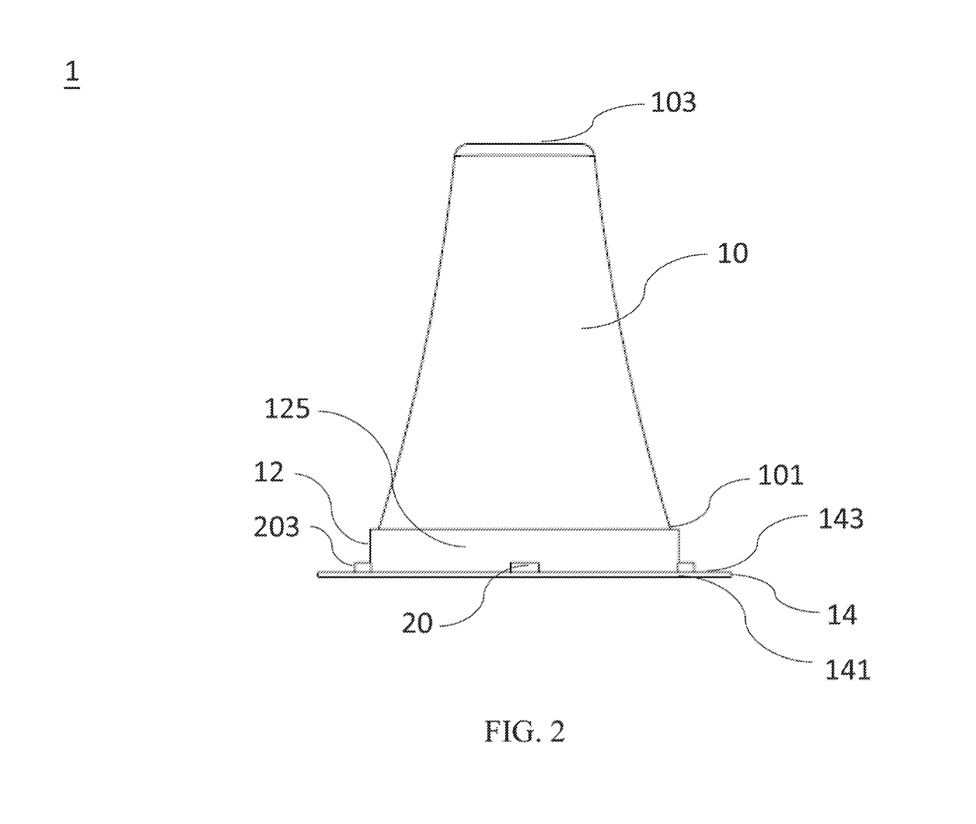

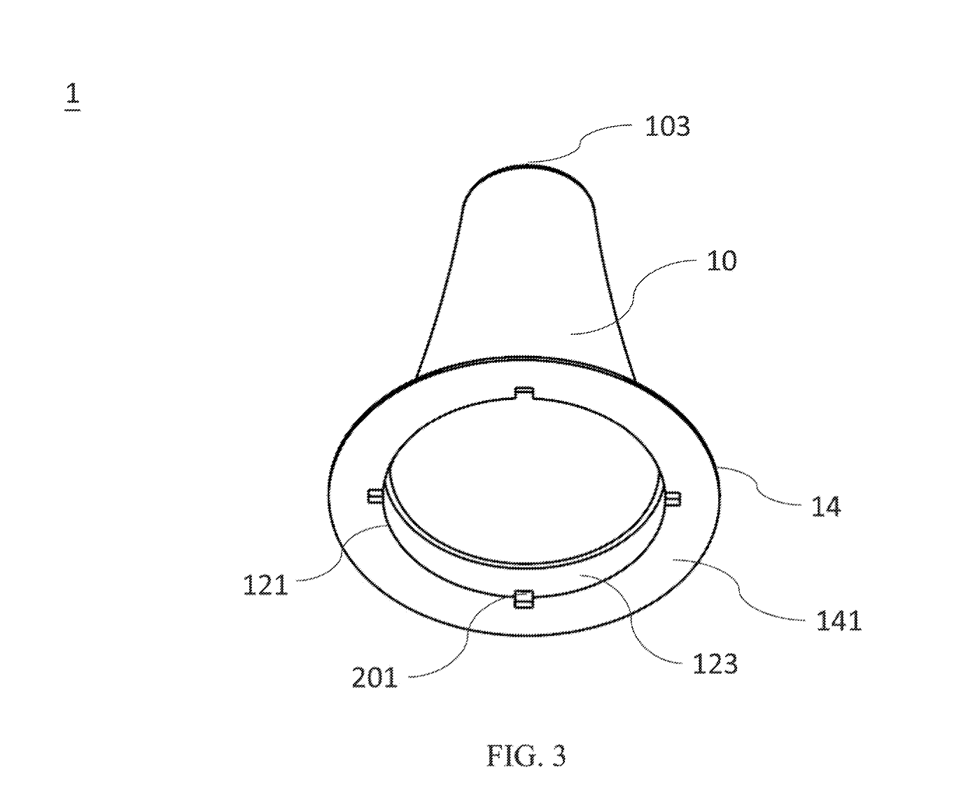

At first, please refer to FIG. 2 and FIG. 3, which are a side view and a top view of a probe cover for ear thermometer in one embodiment of the present invention. As shown in FIG. 2 and FIG. 3, the probe cover 1 for ear thermometer includes a tapered main body 10 with a hollow structure, an annular elastic portion 12, a flange 14 and several elastic recesses 20.

Specifically, the tapered main body 10 includes an opening end 101 and a close end 103 corresponding to the opening end 101. The diameter of the hollow structure is gradually decreased from the open end 101 to the close end 103 and the hollow structure of the tapered main body 10 is a short cone, which a top end thereof is cut. The annular elastic portion 12 is disposed near the open end 121 and formed an annular open end 121 and the annular elastic portion 12 includes an annular inner surface 123 and an annular outer surface 125. The flange 14 is extended from the annular open end 121 to outside and the flange 14 includes a bottom surface 141, which is faced to the same direction as the annular open end 121 and a top surface 143, which is faced to the same direction as the close end 103 and corresponding to the bottom end 141. The top surface is faced to the close end 103. The elastic recesses 20 are respectively and sequentially disposed with the same distance in the annular open end 121, which is at a junction of the flange 14 and the annular elastic portion 12. The elastic recesses 20 are respectively formed as gaps 201 between the annular inner surface 123 and the bottom surface 141 of the flange 14. The elastic outer surface 125 are formed as protruding portion 203 at the elastic recesses 20. The number of the elastic recesses is 4 in the present embodiment and the shape of the gaps 201 formed in the elastic recesses 20 at the junction of the annular inner surface 123 and the bottom surface 141 of the flange 14 is rectangular. The elastic recesses 20 are symmetrically disposed by pair. However, the number and the shape of the elastic recesses in the present invention are not limited herein. For example, the shape can be polygon and the number of the elastic recess can be only one. In addition, the tapered main body 10, the annular elastic portion 12, the flange 14 and the elastic recess 20 are formed integrally and the material thereof is high polymer, but it is not limited in the present invention.

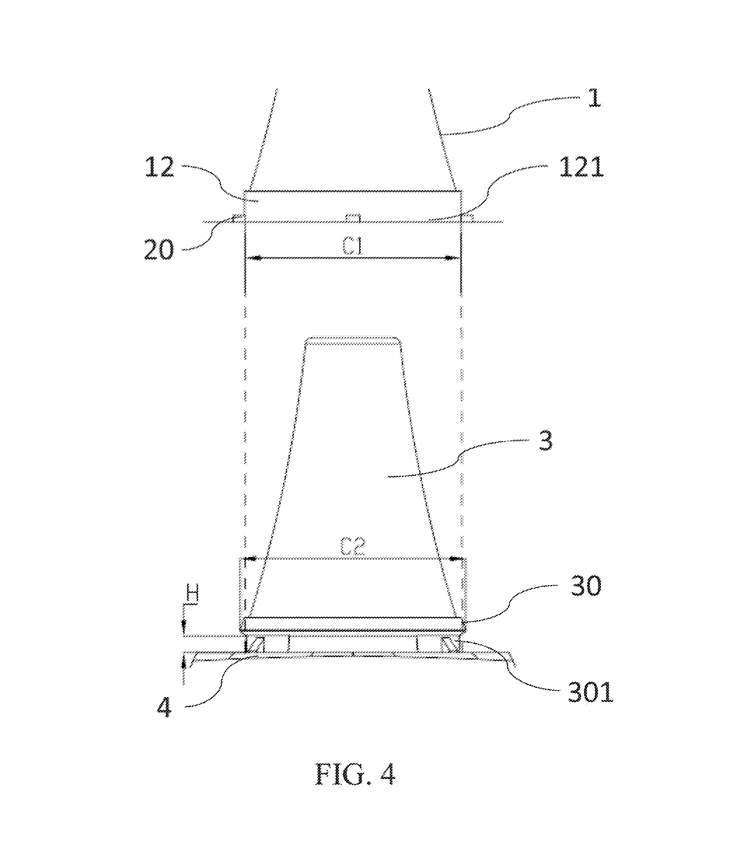

Now, please refer to FIG. 4, which is a bore diameter comparing view illustrating the prove cover for ear thermometer and the probe of the ear thermometer in the embodiment of the present invention. As shown in FIG. 4, when measuring the body temperature, the probe cover 1 for ear thermometer is housing on the probe 3 of the ear thermometer body 4 and there is an annular flange 30 is in the surrounding area of the bottom end of the probe 3. The bore diameter of the annular open end 12 in the present embodiment is C₁ and the bore diameter of the annular flange 30 of the probe 3 is C₂. In order to fix the probe cover 1 on the probe 3, C₂ must be larger than C₁. The annular open end 121 of the probe cover 1 for ear thermometer must be elastic and can be extended properly when the probe cover 1 for ear thermometer is fixed on the probe 3 so as to successfully install.

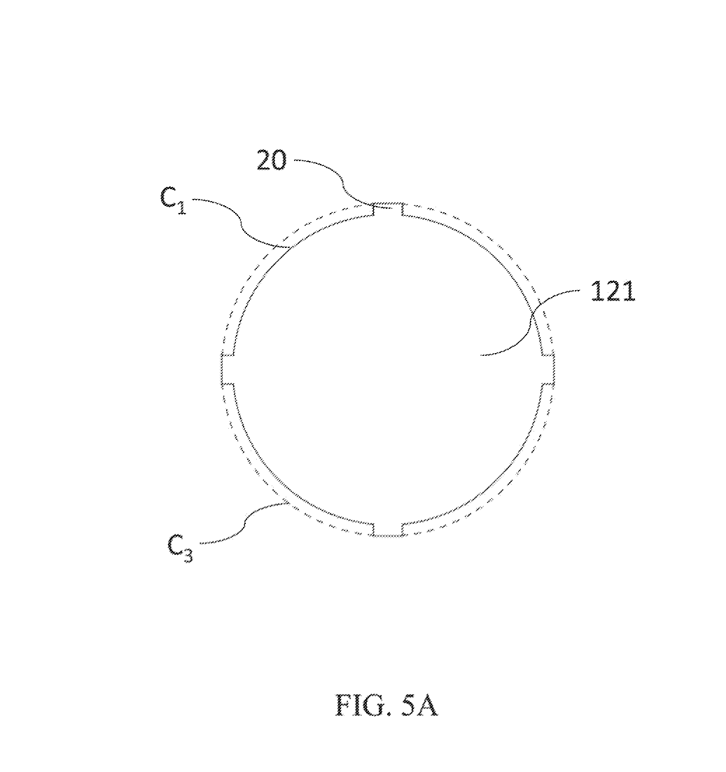

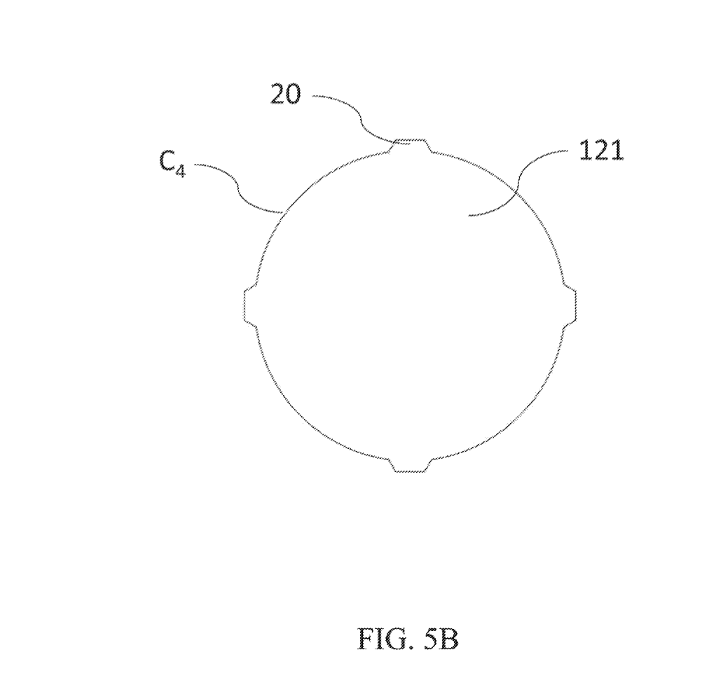

Subsequently, please refer to FIG. 5A and FIG. 5B, which are views illustrating the, extension of the annular open end of the probe cover for ear thermometer in the present embodiment. First of all, as shown in FIG. 5A, before the annular open end 121 is extended, the bore diameter thereof is C₁, and the bore diameter of the external dot lines C₃ is larger than C₁ in accordance with FIG. 5A, the C₃ is represented the limit of the extension of the annular open end 121. Thereafter, please refer to FIG. 4 and FIG. 5B at the same time, as the probe cover 1 for ear thermometer is housing the probe 3, the annular flange 30 of the probe 3 will contact the annular open end 121. Because the bore diameter C₂ of the annular flange 30 is larger than the bore diameter C₁ of the annular open end 121, the annular open end 121 is extended. Because the elastic recess 20 is disposed in the annular open end 121, the annular open end 121 will be extended because of the elasticity thereof in accordance with the elastic recess 20 in the surrounding area of the annular open end 121. The bore diameter C₁ is extended for the annular flange 30 passing through the bore diameter C₄ of the annular open end 121. Therefore, the probe cover 1 for ear thermometer is able to house the probe 3 successfully. An the same time, after the annular flange 30 is passing through the annular open end 121, the annular open end 121 is back to the original bore diameter C₁ because of the spring reversion force of the elastic recess 20 and stuck on the surface of the probe 3. Therefore, the annular open end 121 won't be over extended, which would cause the possibility of the damage of the probe cover 1 for ear thermometer when the probe cover 1 is in use, to reduce an abrasion of the probe 3 of the ear thermometer.

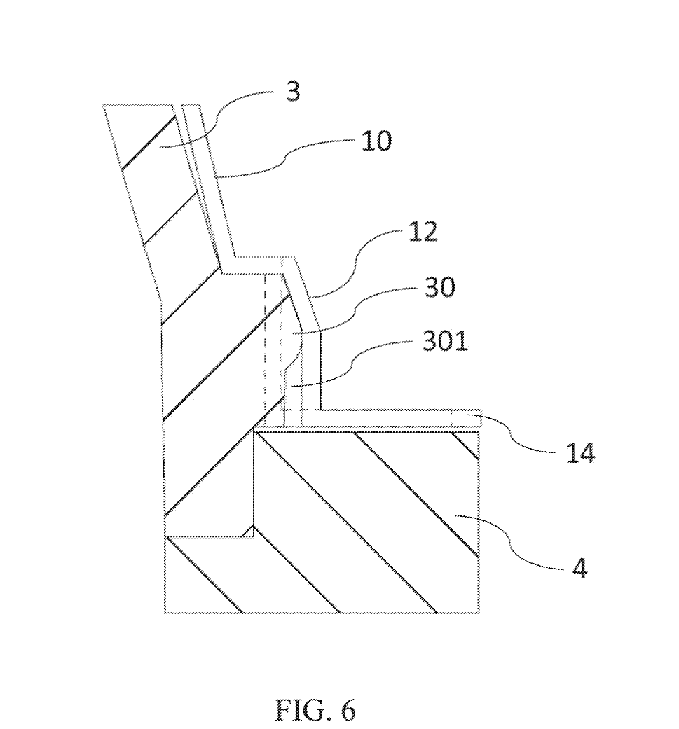

Now, please refer to FIG. 6, which is a view illustrating the probe cover is installed on the ear thermometer in the previous embodiment of the present invention. As shown in FIG. 6, by implementing the extension of the elastic recess 20, the probe cover 1 for ear thermometer can easily and fast house on the probe 3. In addition, please refer to FIG. 4 and FIG. 6 in conjunction, there is a distance H (as shown in FIG. 4) reserved between the annular flange 30 on the probe 3 of the ear thermometer and the main body 4 of the ear thermometer. In other words, there is a gap 301 below the annular flange 30 and an outer circumference thereof is smaller than the bore diameter C₂ of the annular flange 30. Therefore, when annular flange 30 is passing through the annular open end 121 because of the extension (the dot line in FIG. 6 in a non-extension condition) of the annular open end 121, the annular open end 121 will be shrunk because of the elasticity and the spring reversion force of the elastic recess 20 to house the surface of the gap 301 below the annular flange 30 after passing through the annular open end 121 and it is in a condition that the annular elastic portion 12 houses the annular flange 30. The probe cover for ear thermometer is not easy loosed.

As described above, the present invention has been described with preferred embodiments thereof and it is understood that many changes and modifications to the described embodiments can be carried out without departing from the scope and the spirit of the invention that is intended to be limited only by the appended claims.

What is claimed is:

1. A probe cover for ear thermometer, which is utilized for housing a probe of an ear thermometer and a bottom of the probe including an annular component, the probe cover for ear thermometer including a tapered main body with a hollow structure, the tapered main body including a first open end and a close end corresponding to the first open end, a diameter of the hollow structure is gradually shrunk from the first open end to the close end and the probe cover for ear thermometer is characterized in that and comprising:
an annular elastic portion disposed adjacent to the open end to form a second open end, the second open end being an annular shape and the annular elastic portion includes an annular inner surface and an annular outer surface;
a flange extending from the second open end and the flange including a top surface and a bottom surface corresponding to the top surface and the top surface being faced to the close end; and
an elastic recess formed at the second open end, which is an intersection between the flange and the annular elastic portion and gaps being formed at the elastic recess of the annular inner surface and the bottom surface of the flange and protrusions being formed at the elastic recess of the annular outer surface.

2. The probe cover for ear thermometer according to claim 1, wherein the tapered main body, the annular elastic portion, the flange and the elastic recess are formed integrally.

3. The probe cover for ear thermometer according to claim 1, wherein the hollow structure of the tapered body is a short cone, which a top end thereof is cut.

4. The probe cover for ear thermometer according to claim 1, wherein the gaps formed at the elastic recess of the bottom surface of the flange is a rectangular shape.

5. The probe cover for ear thermometer according to claim 1, wherein the gaps formed at the elastic recess of the bottom surface of the flange is a polygon shape.

6. The probe cover for ear thermometer according to claim 1, wherein a material of the probe cover for ear thermometer is high polymer.

7. A probe cover for ear thermometer, which is utilized for housing a probe of an ear thermometer and a bottom of the probe including an annular component, the probe cover for ear thermometer including a tapered main body with a hollow structure, the tapered main body including a first open end and a close end corresponding to the first open end, a diameter of the hollow structure is gradually shrunk from the first open end to the close end and the probe cover for ear thermometer is characterized in that and comprising:
an annular elastic portion disposed adjacent to the open end to form a second open end, the second open end being an annular shape and the annular elastic portion includes an annular inner surface and an annular outer surface;
a flange extending from the second open end and the flange including a top surface and a bottom surface corresponding to the top surface and the top surface being faced to the close end; and
a plurality of elastic recesses equally formed at the second open end, which is an intersection between the flange and the annular elastic portion, with a distance and gaps being formed at the elastic recess of the annular inner surface and the bottom surface of the flange and protrusions being formed at the elastic recesses of the annular outer surface.

8. The probe cover for ear thermometer according to claim 7, wherein the tapered main body, the annular elastic portion, the flange and the elastic recesses are formed integrally.

9. The probe cover for ear thermometer according to claim 7, wherein the hollow structure of the tapered body is a short cone, which a top end thereof is cut.

10. The probe cover for ear thermometer according to claim 7, wherein the elastic recesses are disposed by pair.

11. The probe cover for ear thermometer according to claim 7, wherein the gaps formed at the elastic recess of the bottom surface of the flange is a rectangular shape.

12. The probe cover for ear thermometer according to claim 7, wherein the gaps formed at the elastic recess of the bottom surface of the flange is a polygon shape.

13. The probe cover for ear thermometer according to claim 7, wherein a material of the probe cover for ear thermometer is high polymer.
